(19) United States
(12) Patent Application Publication
(10) Pub. No.: US 2021/0334915 A1
(43) Pub. Date: Oct. 28, 2021

(54) POWER TRANSMISSION AND RECEPTION MANAGEMENT APPARATUS AND COMPUTER-READABLE STORAGE MEDIUM

(71) Applicant: HONDA MOTOR CO.,LTD., Tokyo (JP)

(72) Inventors: Motoki HISHIDA, Saitama (JP); Hakaru SADANO, Saitama (JP); Hiroyuki KANAZAWA, Saitama (JP)

(21) Appl. No.: 17/369,997

(22) Filed: Jul. 8, 2021

Related U.S. Application Data
(63) Continuation of application No. PCT/JP2019/001200, filed on Jan. 17, 2019.

(51) Int. Cl. G06Q 50/06; B60L 53/66; G05B 19/042; H02J 3/32

(52) U.S. Cl. CPC G06Q 50/06; B60L 53/665; G05B 2219/2639; H02J 3/322; G05B 19/042

(57) ABSTRACT

The system comprises: a period specifying unit configured to specify a period in which a vehicle having a driving power supply should be made available to transmit and receive power to/from a power network; and a price control unit configured to, when the vehicle is made available to transmit and receive power to/from the power network in the period specified by the period specifying unit, produce price information for the vehicle being made available to transmit and receive power to/from the power network to correspond the price information to at least one of a user of the vehicle and a person who made the vehicle available to transmit and receive power to/from the power network.

### CROSS REFERENCE TO RELATED APPLICATION

The contents of the following Japanese patent application are incorporated herein by reference:

International Application NO. PCT/JP2019/001200 filed on Jan. 17, 2019.

### BACKGROUND

### 1. Technical Field

The present invention relates to a power transmission and reception management apparatus and a computer-readable storage medium.

### 2. Related Art

There has been a technique for charging electric vehicles, in view of a total amount of charged power to be distributed to charging stands in a power distribution area, to charge a specific vehicle at a charging stand (see, e.g., Patent Document 1 listed below).

### PRIOR ART DOCUMENT

### [Patent Document]

Patent Document 1: Japanese Patent No. 5395764

### BRIEF DESCRIPTION OF THE DRAWINGS

FIG. 1 shows schematically a basic configuration of a power transmission and reception system 100.

FIG. 2 shows schematically a functional configuration of a management server 40.

FIG. 3 shows an exemplary screen 300 for setting a scheduled period to connect a vehicle 30 to a charging/discharging facility 20.

FIG. 4 shows a table of an example of schedule information.

FIG. 5 shows a table of an example of connection history information indicating history of connection by the vehicle 30 to a power network 10.

FIG. 6 shows a table of an example of price information provided by a price control unit 270.

FIG. 7 is a flowchart illustrating processing of giving points to a user 80.

FIG. 8 is a flowchart illustrating processing of notifying the user 80 of point generation information.

FIG. 9 shows schematically how the user 80 other than the user of the vehicle 30 connects the vehicle 30 to the charging/discharging facility 20.

FIG. 10 is a flowchart illustrating processing taken by the user 80 other than the user of the vehicle 30 to connect the vehicle 30 to the charging/discharging facility 20.

FIG. 11 shows an exemplary computer 2000 in which some embodiments of the present invention may be wholly or partially embodied.

### DESCRIPTION OF EXEMPLARY EMBODIMENTS

While the present invention will be described below by means of the embodiments, these embodiments below are not intended to limit the invention defined by the claims. All combinations of features set forth in the embodiments are not necessarily essential to the solutions of the present invention. In figures, the same or similar parts are denoted by the same reference numerals and redundant explanation thereof may be omitted.

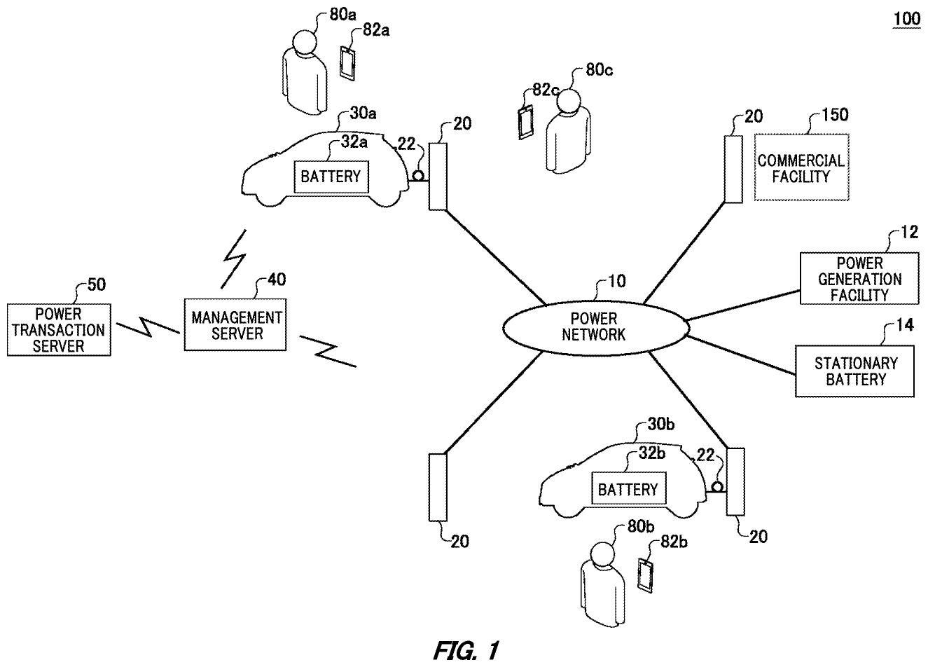

FIG. 1 shows schematically a basic configuration of a power transmission and reception system 100. The power transmission and reception system 100 represents a system for performing V2G (Vehicle-to-Grid) in which a power aggregator, for example, uses batteries mounted on a vehicle to interchange power between the vehicle and a power network. The power transmission and reception system 100 has a framework in which a number of vehicles are guided to connect to the power network. Note that, in the present embodiment, the term V2G applies to at least either of the case where a vehicle discharges power to the power network or the case where a vehicle receives power from the power network.

The power transmission and reception system 100 comprises a plurality of vehicles including vehicles 30a and 30b, a stationary battery 14, a plurality of charging/discharging facilities 20, a management server 40, a power generation facility 12, and a plurality of user terminals including user terminals 82a, 82b, and 82c.

Users 80a, 80b, and 80c are the users of the power transmission and reception system 100. Specifically the user 80a is the user of the vehicle 30a and the user 80b of the vehicle 30b. Note that the users of the vehicles may be any of the owner of the vehicle, a family member of the owner, or anyone who uses the vehicle. The user 80c is not the user of the vehicle 30a nor 30b. In the present embodiment, the respective users 80a, 80b, and 80c may be collectively referred to as “the user(s) 80.”

The vehicle 30a is provided with a battery 32a. The vehicle 30b is provided with a battery 32b. In the present embodiment, a plurality of vehicles including the vehicles 30a and 30b may be collectively referred to as “the vehicle(s) 30.” Similarly, a plurality of batteries including the batteries 32a and 32b may be collectively referred to as “the battery(ies) 32.”

Note that the battery 32 is an example of a driving power supply provided in the vehicle 30. The driving power supply includes a power supply such as fuel cells, that consumes fuel to produce electric energy provided to a power source of the vehicle 30. Fuel may include hydrogen, hydrocarbon fuel including gasoline, light oil, and natural gas, and alcohol fuel. The driving power supply may be any power supply that can produce electric energy provided to the power source of the vehicle 30.

The vehicle 30 is an example of transportation equipment. The vehicle 30 represents electric vehicles or fuel cell vehicles (FCV), for example, that are provided with a power source driven by electric energy The electric vehicles include battery electric vehicles (BEV), hybrid vehicles provided with an internal engine to provide at least a part of power, and plug-in hybrid electric vehicles (PHEV). In the present embodiment, the vehicle 30 is an electric vehicle provided with the battery 32 as the driving power supply. In employing batteries as the driving power supply, battery discharge corresponds to energy release from the driving power supply while battery charge corresponds to energy accumulation in the driving power supply. In addition, a residual capacity of the battery corresponds to an amount of energy accumulated in the driving power supply, such as an amount of power or electricity that can be supplied from the driving power supply.

The user terminal 82a is a communication terminal used by the user 80a. The user terminal 82b is a communication terminal used by the user 80b. The user terminal 82c is a communication terminal used by the user 80c. A plurality of user terminals including the user terminals 82a, 82b, and 82c may be collectively referred to as “the user terminal(s) 82.”

The user terminal 82 may be a mobile terminal, a personal computer, or a vehicle navigation apparatus, for example. The mobile terminal can include a mobile phone, a smart phone, a PDA, a tablet, a notebook computer, a laptop computer, and a wearable computer, as examples.

The management server 40 can communicate, via a communication network, with the vehicle 30, the stationary battery 14, and the user terminal 82. The management server 40 can also communicate, via the communication network, with a power transaction server 50. The communication network may include wired or wireless communication transmission paths. The communication network may include communication networks such as the Internet, a P2P network, a dedicated line, a VPN, a power line communication line, a mobile telephone line and so on.

The power network 10 can include a transmission system or distribution system of a power system, or a distribution network of a power grid. The power network 10 may be provided for each area. The power network 10 may be a microgrid. The power network 10 may be a distribution network of any scale that connects between electric equipment which consumes power and a power supply. For example, the power network 10 may be a distribution network provided in any facility such as a commercial facility 150. The power network 10 may be provided for each building. The vehicle 30, the stationary battery 14, the charging/discharging facility 20, and the power generation facility 12 are connected to the power network 10. The charging/discharging facility 20, the stationary battery 14, and the power generation facility 12 can transmit and receive power to/from the power network 10.

The power generation facility 12 is managed by an electric power company or the like. The charging/discharging facility 20 includes chargers/dischargers installed in residences, and charging/discharging stands installed in parking lots or public spaces of apartments, buildings, or the commercial facility 150, for example.

The vehicle 30 is connected to the charging/discharging facility 20 through a charging/discharging cable 22. That is, the vehicle 30 is connected to the power network 10 through the charging/discharging cable 22 and the charging/discharging facility 20. The vehicle 30 transmits and receives power between the battery 32 and the power network 10 through the charging/discharging facility 20. For example, the vehicle 30 releases power discharged from the battery 32 to the power network 10 via the charging/discharging cable 22 and the charging/discharging facility 20. The vehicle 30 also charges the battery 32 with power supplied from the power network 10 via the charging/discharging cable 22 and the charging/discharging facility 20. Note that the transmission and reception of power to/from the power network 10 may be referred to as “the power transmission and reception with the power network 10.”

The stationary battery 14 is managed by a power aggregator. The battery 32 of the vehicle 30 forms a virtual power plant with the stationary battery 14. The management server 40 is managed by the power aggregator. The management server 40 controls power transmission and reception between the battery 32 and the power network 10, and between the stationary battery 14 and the power network 10.

The management server 40 carries out power transactions by bidding at a wholesale power market. The power transaction server 50 is managed by an operator of the wholesale power market. The management server 40 places a bid in a 30-minute time frame in the power transaction server 50. The management server 40, based on a contract result, causes the battery 32 and the stationary battery 14 to discharge power in every time frame to supply the power to the power network 10.

For example, the management server 40, according to a contract amount for the bidding by the power aggregator in the wholesale power market, causes the battery 32 and the stationary battery 14 to discharge power to supply the power to the power network 10. In addition, the management server 40 controls charging/discharging of the battery 32 and the stationary battery 14 to balance the power supply and demand in the power network 10 to an extent of balancing power contracted for the bidding by the power aggregator in the supply/demand balancing market. For example, the management server 40 controls charging/discharging of the battery 32 and the stationary battery 14 according to an increased-demand response (increased-DR), a decreased-demand response (decreased-DR), and an increased/decreased-demand response (increased/decreased-DR) from an electricity transmission and distribution utility or an electricity retailer.

Specifically, the management server 40 controls at least one of the vehicle 30 and the charging/discharging facility 20 according to the increased-DR to charge the battery 32 of the vehicle 30 with power received from the power network 10 through the charging/discharging facility 20. The management server 40 also controls at least one of the vehicle 30 and the charging/discharging facility 20 according to the decreased-DR to cause the battery 32 of the vehicle 30 to discharge power so as to release the power discharged from the battery 32 toward the power network 10 through the charging/discharging facility 20.

In the present embodiment, the management server 40 acquires a scheduled period in which the vehicle 30 is connected to the charging/discharging facility 20 from each user 80 of the vehicle 30. The management server 40, when the vehicle 30 is connected to the charging/discharging facility 20 in the scheduled period, gives the user 80 a price for the vehicle 30 being connected to the charging/discharging facility 20. Note that the management server 40 gives a price to the user 80 regardless of whether or not power is transmitted and received between the vehicle 30 and the charging/discharging facility 20. This can encourage the user 80 to connect the vehicle 30 to the charging/discharging facility 20 at any time. This facilitates the power aggregator to ensure the capacity capable of transmitting and receiving power between the vehicle 30 and the power network 10.

Note that, in the present embodiment, the power transmission and reception means that the power is transferred from at least one of the vehicle 30 and the power network 10 to the other. For example, the power transmission and reception may mean that power is released from the vehicle 30 toward the power network 10. The power transmission and reception may also mean that power is transmitted from the power network 10 toward the vehicle 30. Note that, in the case where power is released from the vehicle 30 through a charger/discharger installed at a power consumer such as a home, if the power consumption on the power consumer side is greater than the amount of power released from the vehicle 30, no net power may be supplied to the power network 10 at a connection point between the power consumer side and the power network 10, and the amount of power supply from the connection point to the power consumer may simply decrease. This case can also be considered that, as seen from the perspective of the power network 10, power is exchanged with the outside of the power network 10. Accordingly in the present embodiment, in the power transmission and reception with the power network 10 by releasing the power from the vehicle 30, it does not matter whether the power network 10 receives net power from a particular connection point with the vehicle 30.

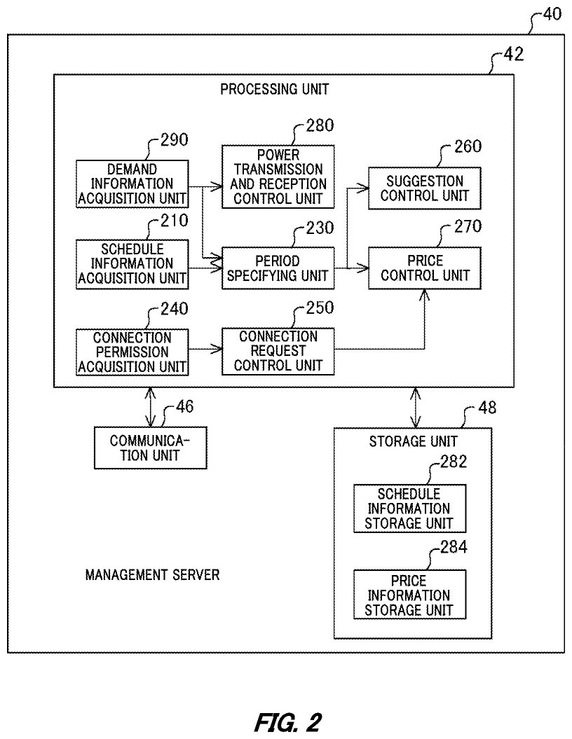

FIG. 2 shows schematically a functional configuration of the management server 40. The management server 40 comprises a processing unit 42, a storage unit 48, and a communication unit 46.

The processing unit 42 is implemented by a processing device including a processor. The storage unit 48 is implemented by a non-volatile storage device. The processing unit 42 performs processing using information stored in the storage unit 48. The communication unit 46 is responsible for communication among the vehicle 30, the stationary battery 14, the user terminal 82, and the power transaction server 50. Information received by the communication unit 46 from the vehicle 30, the stationary battery 14, the user terminal 82, and the power transaction server 50 is supplied to the processing unit 42. In addition, information transmitted to the vehicle 30, the stationary battery 14, the user terminal 82, and the power transaction server 50 is produced by the processing unit 42 and transmitted via the communication unit 46.

The management server 40 functions as a power transmission and reception control device. The management server 40 may be a system implemented in a single information processing device or in a plurality of information processing devices.

The processing unit 42 comprises a schedule information acquisition unit 210, a period specifying unit 230, a connection permission acquisition unit 240, a connection request control unit 250, a suggestion control unit 260, a price control unit 270, a power transmission and reception control unit 280, and a demand information acquisition unit 290. The storage unit 48 comprises a schedule information storage unit 282 and a price information storage unit 284.

The period specifying unit 230 specifies a period in which the vehicle 30 comprising the battery 32 should be made available to transmit and receive power to/from the power network 10. The price control unit 270, when the vehicle 30 is made available to transmit and receive power to/from the power network 10 in a period specified by the period specifying unit 230, produces price information indicating a price for the vehicle 30 being made available to transmit and receive power to/from the power network 10. The price control unit 270 corresponds the price information to at least any of the vehicle 30, the user 80 of the vehicle 30, the user 80 whose vehicle 30 is made available to transmit and receive power to/from the power network 10, and the vehicle 30 used by the user 80. Note that the price control unit 270 may correspond the price information to any information which enables specifying the user 80 of the vehicle 30 or the user 80 whose vehicle 30 is made available to transmit and receive power to/from the power network 10.

The price control unit 270 produces the price information when the charging/discharging facility 20, which charges/discharges the vehicle 30 through power transmission and reception to/from the power network 10, and the vehicle 30 are connected to each other for the period specified by the period specifying unit 230. The charging/discharging facility 20 is an example of a power transmission and reception facility for transmitting and receiving power between the vehicle 30 and the power network 10.

The schedule information storage unit 282 corresponds information indicating a scheduled period in which the vehicle 30 is connected to the charging/discharging facility 20 to identification information of the vehicle 30 for storage. For example, the schedule information acquisition unit 210 preliminarily acquires information for specifying a scheduled period from the user of the vehicle 30, and the schedule information storage unit 282 corresponds the period acquired by the schedule information acquisition unit to the identification information of the vehicle 30 for storage. The period specifying unit 230 specifies the scheduled period corresponded to the identification information of the vehicle 30 and stored in the schedule information storage unit 282 as a period in which the vehicle 30 should be made available to transmit and receive power to/from the power network 10.

Note that the price control unit 270, when the charging/discharging facility 20 and the vehicle 30 are connected to each other, produces first price information if the period in which the charging/discharging facility 20 and the vehicle 30 are connected to each other does not include the scheduled period. The price control unit 270 produces second price information indicating a higher price than that of the first price information if the period in which the charging/discharging facility 20 and the vehicle 30 are connected to each other includes the scheduled period.

The price control unit 270 corresponds the price information to the user 80 of the vehicle 30. When the user 80 other than the user of the vehicle 30 connects the vehicle 30 to the charging/discharging facility 20, the price control unit 270 may correspond the price information to the user 80 other than the user of the vehicle 30. For example, the price control unit 270 corresponds the price information to the user 80 other than the user of the vehicle 30 when the vehicle 30, which has not been connected to the charging/discharging facility 20 before the period specified by the period specifying unit 230, is connected to the charging/discharging facility 20 by the user 80 other than the user of the vehicle 30. Note that the user 80 other than the user of the vehicle 30a may include the users 80b and 80c. In addition, the user 80 other than the user of the vehicle 30b may include the users 80a and 80c.

The connection request control unit 250, when the vehicle 30 is not connected to the charging/discharging facility 20 at a predetermined time point before the period specified by the period specifying unit 230, requests the user 80 other than the user of the vehicle 30 to connect the vehicle 30 to the charging/discharging facility 20. The price control unit 270 corresponds the price information to the user 80 when the vehicle 30 is connected to the charging/discharging facility 20 by the user 80 to whom the connection request control unit 250 provided the request for connection.

The connection permission acquisition unit 240 acquires permission information to permit the user 80 other than the user of the vehicle 30 to connect the vehicle 30 to the charging/discharging facility 20 from the user 80 of the vehicle 30. The connection request control unit 250 may request any other person to connect the vehicle 30 to the charging/discharging facility 20 under the condition that the connection permission acquisition unit 240 acquires the permission information.

The connection request control unit 250, at a predetermined time point before the period specified by the period specifying unit 230, requests any other person, whose vehicle 30 is not connected to the charging/discharging facility 20 and who is near the vehicle 30 parked in the vicinity of the charging/discharging facility 20, to connect the vehicle 30 to the charging/discharging facility 20.

The price information storage unit 284 stores information indicating the amount of the price information corresponded to each of the user 80 of the vehicle 30 and the user 80 other than the user of the vehicle 30. The price control unit 270 permits the user 80 of the vehicle 30 to use a charging facility preferentially depending on the amount of the price information corresponded to the respective users 80. The charging facility of the vehicle 30 may be the charging/discharging facility 20 or the stationary battery 14. The stationary battery 14 can be used as the charging facility to charge the vehicle 30 in a time of emergency. Note that the charging/discharging facility 20 and the stationary battery 14 are an example of an electric facility for accumulating energy in the driving power supply provided in the vehicle 30.

Note that the period specifying unit 230, based on the period in which the vehicle 30 is made available to transmit and receive power to/from the power network 10 and history of the price information produced for the vehicle 30 being made available to transmit and receive power to/from the power network 10, predicts a future period in which a price is generated by making the vehicle 30 available to transmit and receive power to/from the power network 10. The period specifying unit 230 specifies the predicted future period as a period in which the vehicle 30 should be made available to transmit and receive power to/from the power network 10. The suggestion control unit 260 suggests the future period predicted by the period specifying unit 230 to the user of the vehicle 30. Note that the period specifying unit 230 may, based on the period in which the vehicle 30 is made available to transmit and receive power to/from the power network 10 and the history of the price information, predict a future period and location where a price is generated by making the vehicle 30 available to transmit and receive power to/from the power network 10. The suggestion control unit 260 may suggest the future period and location predicted by the period specifying unit 230 to the user of the vehicle 30.

The demand information acquisition unit 290 acquires information indicating power demand in the power network 10. The period specifying unit 230 may, based on the power demand in the power network 10, specify a period in which power transmission and reception for the power network 10 is required.

Note that the contract amount in power transaction described above is an example of information indicating the power demand. The information indicating the power demand may be a contract price in power transaction or a contract type indicating whether a transaction is a buy contract or a sell contract. In addition, the information indicating the power demand may be information indicating an amount of real-time imbalance between supply and demand in the power network 10, or may be information indicating a predicted amount of future imbalance between supply and demand. The information indicating the power demand may be information indicating an amount of real-time power consumption of the power consumer in the power network 10 or a predicted value of the power consumption. As the information indicating the power demand, various types of information, aside from the amounts of power themselves, that directly or indirectly affect the power demand are applicable such as temperature information, humidity information, weather information, and event information.

Note that examples of the power transaction market can include transaction markets such as a day-ahead market, an intraday market, and a supply/demand balancing power market. As the transaction form of power transaction, various transaction forms are applicable other than the transaction forms in these power transaction markets.

The power transmission and reception control unit 280 causes the vehicle 30 to transmit and receive power to/from the power network 10 depending on the power demand in the power network 10. The power transmission and reception control unit 280 communicates with an ECU of the vehicle 30 to successively acquire information about whether power can be transmitted or received that indicates whether the vehicle 30 is connected to the charging/discharging facility 20 capable of transmitting and receiving power to/from the power network 10. The power transmission and reception control unit 280, when the vehicle 30 can transmit and receive power to/from the power network 10, instructs the ECU provided in the vehicle 30 to charge/discharge the battery 32 according to the power demand acquired by the demand information acquisition unit 290. The ECU in the vehicle 30 follows the instruction from the power transmission and reception control unit 280 to communicate with the charging/discharging facility 20 and control a power converter of the vehicle 30 so as to charge the battery 32 through the charging/discharging facility 20 or release power obtained from discharging the battery 32. Note that the power transmission and reception control unit 280 may successively acquire, from the ECU in the vehicle 30, information indicating an amount of input power from the charging/discharging facility 20 to the power converter upon charging the battery 32, an amount of output power from the power converter to the charging/discharging facility 20 upon discharging the battery 32, and an SOC (State of Charge) of the battery 32. The power transmission and reception control unit 280 may control power transmission and reception between the vehicle 30 and the power network 10 based on the information acquired from the ECU in the vehicle 30.

The management server 40 allows the user 80 to earn a price by connecting the vehicle 30 to the charging/discharging facility 20 at a scheduled period. As such, the user 80 can be encouraged to connect the vehicle 30 to the charging/discharging facility 20, and thus many vehicles 30 can be guided to be connected to the charging/discharging facilities 20. Accordingly it facilitates the power aggregator to ensure the power transmission and reception capacity between the vehicle 30 and the power network 10.

Note that the functions of the power transmission and reception management apparatus may be implemented by the management server 40 alone or may be implemented by a combination of the management server 40 and the ECU in the vehicle 30. For example, at least a part of processing to be executed by the management server 40 may be executed by the ECU in the vehicle 30. For example, at least a part of the functions to be implemented by the schedule information acquisition unit 210, the period specifying unit 230, the connection permission acquisition unit 240, the connection request control unit 250, the suggestion control unit 260, the price control unit 270, the power transmission and reception control unit 280, the demand information acquisition unit 290, the schedule information storage unit 282, and the price information storage unit 284 may be implemented by the ECU in the vehicle 30.

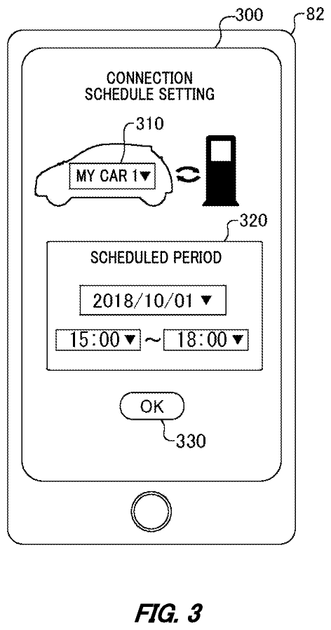

FIG. 3 shows an exemplary screen 300 for setting the scheduled period to connect the vehicle 30 to the charging/discharging facility 20. The screen 300 is displayed on the user terminal 82 under the control of the management server 40. The screen 300 includes a selection menu 310 of the vehicle 30, an input menu 320 of the scheduled period, and a determination button 330.

The selection menu 310 is for selecting the target vehicle 30 to connect to the charging/discharging facility 20. The input menu 320 is for setting a scheduled connection date, a start time of scheduled connection time in the scheduled connection date, and an end time of scheduled connection time. The scheduled period is determined by the scheduled connection date, the start time, and the end time. Note that the scheduled connection date may be settable by a specific date itself, or by one or more dates using information such as “weekdays,” “Saturdays and Sundays,” “Saturdays and holidays,” or “October,” The start time and end time of the scheduled connection time may be settable by any unit such as a 30-minute time frame or one hour.

By the user 80 pressing the determination button 330, the user terminal 82 transmits identification information of the user 80, identification information of the vehicle 30, and information indicating the scheduled period to the management server 40. In the management server 40, the schedule information acquisition unit 210 corresponds the information indicating the vehicle 30 and the scheduled period transmitted from the user terminal 82 to the identification information of the user 80 to store it in the schedule information storage unit 282.

Note that the user 80 may access the management server 40 from the user terminal 82 to set the scheduled period by himself/herself. In addition, the management server 40, based on the power demand acquired by the demand information acquisition unit 290 or travel history of the user 80 or the vehicle 30, may acquire the scheduled period by determining the scheduled period to be suggested to the user 80, transmitting information indicating the determined scheduled period to the user terminal 82 with push notification, and causing the user 80 to select whether to accept the suggested scheduled period.

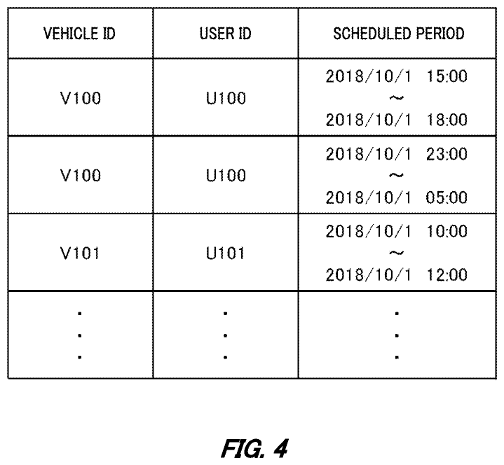

FIG. 4 shows a table of an example of the schedule information. The schedule information is stored in the schedule information storage unit 282 of the storage unit 48. The schedule information corresponds a vehicle ID, a user ID, and the information indicating the scheduled period to each other.

The vehicle ID stores the identification information of the vehicle 30. The vehicle ID may store the identification information of the vehicle 30 set by the user 80 through the screen 300 as shown in FIG. 3 or the like. The user ID stores the identification information of the user 80. The scheduled period stores the information indicating the scheduled period in which the vehicle 30 of the user 80 is connected to the charging/discharging facility 20. The scheduled period may store the information indicating the scheduled period set by the user 80 through the screen 300 as shown in FIG. 3 or the like.

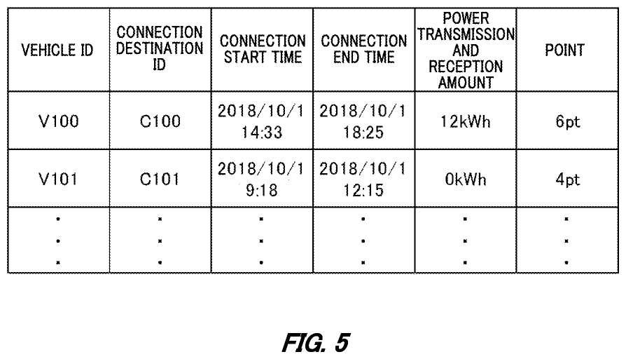

FIG. 5 shows a table of an example of connection history information indicating history of connection by the vehicle 30 to the power network 10. The connection history information is stored in the storage unit 48. The connection history information corresponds the vehicle ID, a connection destination ID, connection start time, connection end time, a power transmission and reception amount, and a point to each other.

The vehicle ID stores the identification information of the vehicle 30. The connection destination ID stores the identification information of the charging/discharging facility 20 to which the vehicle 30 is connected. The connection start time stores time when the vehicle 30 is made available to transmit and receive power to/from the power network 10. The connection start time may be specified based on the information about whether power can be transmitted or received, which is transmitted regularly from the charging/discharging ECU in the vehicle 30 to the management server 40. The connection start time may store time when the power transmission and reception control unit 280 is made available to control charging/discharging of the battery 32 after the charging/discharging cable 22 is attached to the vehicle 30 and the charging/discharging facility 20.

The connection end time stores time when power transmission and reception between the vehicle 30 and the power network 10 is made unavailable. The connection end time may be specified based on the information about whether power can be transmitted or received, which is transmitted regularly from the charging/discharging ECU in the vehicle 30 to the management server 40. The connection end time may store end time of the period in which the vehicle 30 is connected to the charging/discharging facility 20 through the charging/discharging cable 22. The connection end time may store time when the power cable is disconnected from at least one of the vehicle 30 and the charging/discharging facility 20. The connection end time may store time when the power transmission and reception control unit 280 is made unavailable to control charging/discharging of the battery 32.

The power transmission and reception amount stores a net amount of power transmitted and received between the vehicle 30 and the power network 10 during the period from the connection start time to the connection end time. The price control unit 270, based on the power transmission and reception amount of each vehicle 30, produces amount of money information payable to the respective users 80 of the vehicles 30 and stores the information in the storage unit 48. The amount of money payable to the user 80 is calculated according to the power transmission and reception amount. When a positive net amount of power is transmitted from the vehicle 30 to the power network 10, the price control unit 270 calculates an amount payable to the user 80 based on the power transmission and reception amount and a power buying unit price. When a negative net amount of power is transmitted, the price control unit 270 calculates a billing amount to the user 80 based on the power transmission and reception amount and a power selling unit price. The power buying unit price is a price per unit amount of power the power aggregator buys from the user 80. The power selling unit price is a price per unit amount of power the power aggregator sells to the user 80.

The point stores information indicating the price given to the user for connecting the vehicle 30 to the power network 10. The information stored in the point is calculated from the price control unit 270. The price control unit 270 gives a price to the user 80 when the scheduled period stored in the schedule information storage unit 282 is included between the connection start time and the connection end time. For example, the price control unit 270 determines, for each 30-minute time frame included in the scheduled period, whether the entire period of each time frame is included in a period from the connection start time to the connection end time. The price control unit 270 gives a predetermined point to the user 80 for every time frame included between the connection start time and the connection end time. Note that, in the present embodiment, a point is given for each time frame of the power transaction. Any time period other than the time frame is applicable as a unit time for giving a point.

Note that the connection history information may be stored in any form as long as the information is able to specify whether the vehicle 30 has been available to transmit and receive power to/from the power network 10 regardless of whether power is actually transmitted and received between the vehicle 30 and the power network 10.

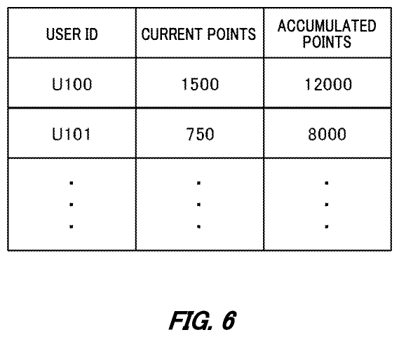

FIG. 6 shows a table of an example of the price information given to the user. The price information is stored in the price information storage unit 284. The price information corresponds the user ID, current points, and accumulated points to each other.

The user ID stores the identification information of the user 80. The current points store current points provided to the user 80.

The accumulated points store a sum of points that have been provided to the user 80 to present. The accumulated points may store a sum of points that have been provided to the user 80 from a time point a predetermined period earlier to present. The price control unit 270 calculates the accumulated points by summing the points stored in the connection history information for each user.

The accumulated points can be used as an expected value for the user 80 to connect the vehicle 30 to the charging/discharging facility 20 in the scheduled period. The accumulated points can be used as confidence information for the user 80. The price control unit 270 may give the price such as a coupon available in the commercial facility 150 preferentially to the user 80 having higher accumulated points. The current points provided to the user 80 may be usable to pay a price for purchase in the commercial facility 150. In addition, the price control unit 270 may set the power buying unit price from the battery 32 of the vehicle 30 and the power selling unit price to the vehicle 30 depending on the accumulated points. For example, the price control unit 270 may increase the power buying unit price and decrease the power selling unit price as the accumulated points get higher.

Note that, in the power transmission and reception system 100, the user 80 can use the points provided to the user 80 for charging the vehicle 30 by the stationary battery 14 in a time of emergency or disaster. For example, when the current points of the user 80 are equal to or higher than a predetermined value and a residual capacity in the battery 32 of the vehicle 30 of the user 80 is at a predetermined level or lower, the processing unit 42 of the management server 40 permits charging the battery 32 by the stationary battery 14 in exchange of subtracting a predetermined number of points from the current points provided to the user 80. The management server 40 may specify the user 80 of the vehicle 30 connected to the stationary battery 14 from the identification information of the vehicle 30 connected to the stationary battery 14 or the identification information of the user 80 stored in a user card of the stationary battery 14, and permit charging the battery 32 by the stationary battery 14 when the current points corresponded to the specified user 80 are equal to or higher than the predetermined value. In addition, the processing unit 42 may give permission to charge the battery 32 by the stationary battery 14 preferentially to the user 80 having higher current points or previous accumulated points.

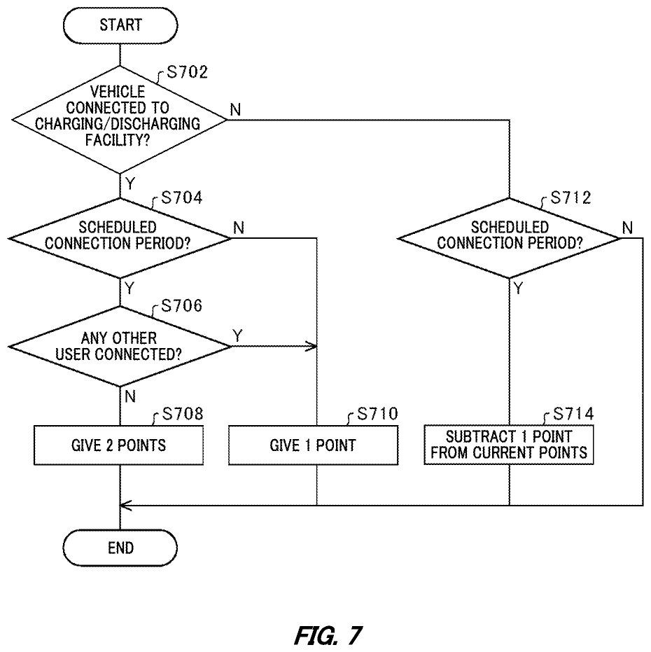

FIG. 7 is a flowchart illustrating processing of giving points to the user 80. The flowchart in FIG. 7 is executed mainly in the processing unit 42 of the management server 40. The processing of the flowchart in FIG. 7 is executed, for example, for any combination of the unit time frame serving as a target to give points and the user 80.

At S702, the price control unit 270 determines whether the vehicle 30 has been connected to the charging/discharging facility 20 for the entire period of the time frame as a determination target. For example, the price control unit 270, based on the connection history information stored in the storage unit 48, determines whether the entire time frame is included in the period between the connection start time and the connection end time.

If the vehicle 30 is connected to the charging/discharging facility 20, the price control unit 270, at S704, determines whether the time frame as the determination target is included in the scheduled period. For example, the price control unit 270 refers to the schedule information storage unit 282 to determine whether the time frame as the determination target is included in the scheduled period.

If the time frame as the determination target is included in the scheduled period, the price control unit 270, at S706, determines whether the vehicle 30 is connected to the charging/discharging facility 20 by the user 80 other than the user of the vehicle 30. If the vehicle 30 is not connected to the charging/discharging facility 20 by the user 80 other than the user of the vehicle 30, the price control unit 270, at S708, gives two points to the user 80. For example, the price control unit 270 adds two points to the current points and the accumulated points corresponded to the identification information of the user 80 in the price information storage unit 284.

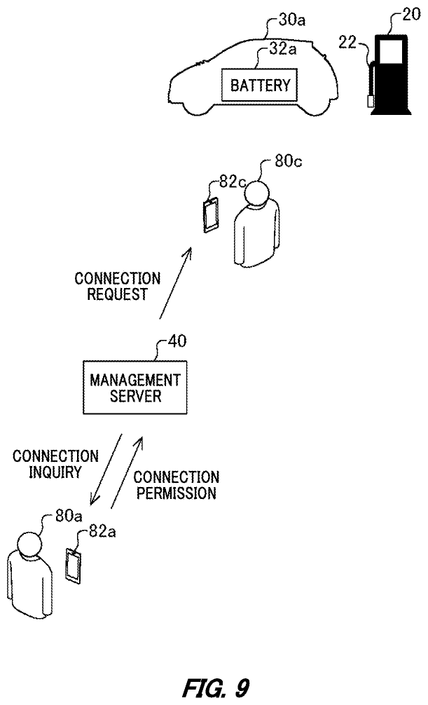

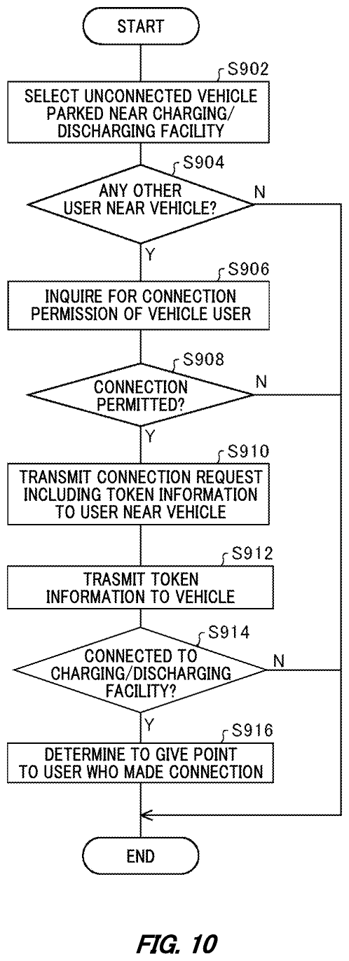

If it is determined at S706 that the vehicle 30 is connected to the charging/discharging facility 20 by the user 80 other than the user of the vehicle 30, the price control unit 270, at S710, gives one point to the user 80. For example, the price control unit 270 adds one point to the current points and the accumulated points corresponded to the identification information of the user 80 in the price information storage unit 284. Note that the cases where the user 80 other than the user of the vehicle 30 connects the vehicle 30 to the charging/discharging facility 20 will be described in more detail with reference to FIG. 9 and FIG. 10.

If it is determined at S704 that the time frame as the determination target is not included in the scheduled period, the price control unit 270, at S710, gives one point to the user 80. Accordingly while a point is given to the user 80 by connecting the vehicle 30 to the charging/discharging facility 20 even if the connection is made outside the scheduled period, higher points can be given to the user 80 when the connection is made during the scheduled period.

If it is determined at S702 that the vehicle 30 is not connected to the charging/discharging facility 20, the price control unit 270, at S712, determines whether the time frame as the determination target is included in the scheduled period. For example, the price control unit 270 refers to the schedule information storage unit 282 to determine whether the time frame as the determination target is included in the scheduled period.

If it is determined at S712 that the time frame as the determination target is not included in the scheduled period, the price control unit 270, at S714, subtracts one point from the points given to the user 80. For example, the price control unit 270 subtracts one point from the current points corresponded to the identification information of the user 80 in the price information storage unit 284. The price control unit 270 may subtract one point from the current points only when the current points is positive corresponded to the identification information of the user 80 in the price information storage unit 284.

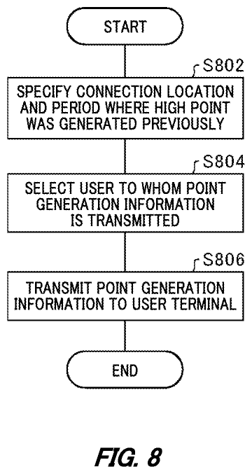

FIG. 8 is a flowchart illustrating processing of notifying the user 80 of the point generation information that indicates future connection location and period where a high point can be earned. The flowchart in FIG. 8 is executed mainly in the processing unit 42 of the management server 40. The processing of the flowchart in FIG. 8 may be executed regularly. For example, the processing of the flowchart in FIG. 8 may be executed every day.

At S802, the period specifying unit 230 specifies the connection location and period where a high point was previously given. For example, the period specifying unit 230 refers to the connection history information stored in the storage unit 48 to calculate the points predicted to be generated within the prediction target period starting from the next day for each connection location and period. For example, the period specifying unit 230 refers to the connection history information to sum the points previously given to any user 80 on the same day of the week as the day including the prediction target period for each connection location and each 30-minute time frame. The period specifying unit 230 specifies the connection location and period at which the sum of the points exceeds a predetermined value.

Note that the connection location may be an installation location of the charging/discharging facility 20 to which the vehicle 30 is connected, such as the commercial facility 150, a parking lot, and a charging station, for example. The period specifying unit 230 may specify a connection location based on the connection destination ID. For example, the storage unit 48 stores installation information that corresponds identification information of an installation location of the charging/discharging facility 20 to the identification information of the charging/discharging facility 20. The installation location is, for example, the commercial facility 150, the parking lot, the charging station, or the like having one or more charging/discharging facility 20 installed therein. The period specifying unit 230 specifies the connection location based on the installation information stored in the storage unit 48 and the connection destination ID included in the connection history information.

At S804, the suggestion control unit 260 selects the user 80 as a transmission destination of point generation information indicating the connection location and period selected at S802. The suggestion control unit 260 selects the user 80 as the transmission destination of the point generation information based on the connection location selected at S802. For example, the storage unit 48 stores address information indicating an address associated with the user 80. The address associated with the user 80 may be an address of a residence or office of the user 80. The suggestion control unit 260 refers to the address information to select the user 80 associated with the address within a predetermined range from the connection location selected at S802 as the user 80 serving as the transmission destination of the point generation information.

At S806, the suggestion control unit 260 transmits the point generation information including the connection location and period specified at S802 to the user terminal 82 of the user 80 selected at S804 through the communication unit 46. For example, the point generation information transmitted to the user terminal 82 may include information indicating the connection location and period, as well as a message such as “High V2G point is generated at the shopping mall XX on every Wednesday between 19:00 and 21:00.”

The user terminal 82, upon receiving the point generation information, displays the massage included in the point generation information and a button for making a reservation to connect the vehicle 30 to the power network 10 on the connection location and period indicated in the point generation information. When the user 80 selects the button, the user terminal 82 displays the screen for setting the scheduled period as shown in FIG. 3, based on the connection location and period included in the point generation information.

The processing of the flowchart shown in FIG. 8 enables to suggest the user 80 the location and period where a high point is predicted to be given. As such, it can motivate the user 80 to connect the vehicle 30 to the power network 10.

The control by the management server 40 can encourage the user 80 to appropriately connect the vehicle 30 to the charging/discharging facility 20 at the scheduled period, facilitating the power aggregator to ensure the required capacity of transmitting and receiving power to/from the power network 10.

FIG. 9 shows schematically how the user 80 other than the user of the vehicle 30 connects the vehicle 30 to the charging/discharging facility 20. Referring to FIG. 9, a case will be explained where the user 80c, instead of the user 80a, connects the vehicle 30a.

In FIG. 9, the vehicle 30a is parked in the parking lot or the like while not connected to the charging/discharging facility 20. The user 80a is moving away from the vehicle 30a without connecting the vehicle 30a to the charging/discharging facility 20.

When the vehicle 30a is not connected to the charging/discharging facility 20 at a time point earlier for a predetermined time before the start time of the scheduled period to connect the vehicle 30a to the charging/discharging facility 20, and the user 80a is away from the vehicle 30a by a predetermined distance or more, the connection permission acquisition unit 240 transmits inquiry information for inquiring whether any other user can connect the vehicle 30a to the charging/discharging facility 20 to the user terminal 82a of the user 80a. When the user 80a operates the user terminal 82a to permit any other user to connect the vehicle 30a to the charging/discharging facility 20, the user terminal 82a transmits connection permission information to the management server 40.

When the connection permission acquisition unit 240 acquires the connection permission information from the user terminal 82, the connection request control unit 250 searches the user 80c near the vehicle 30a and transmits a connection request, to the user terminal 82c, including token information to connect the vehicle 30a to the charging/discharging facility 20. The token information is for limiting the user 80 who is permitted to connect the vehicle 30a to the charging/discharging facility 20. As will be described below, the same token information is also transmitted to the vehicle 30a, and the vehicle 30a determines whether the user 80c is permitted to connect the vehicle 30a to the charging/discharging facility 20 from the token information. Note that the connection request control unit 250 may include information for specifying the vehicle 30a in the connection request. The information for specifying the vehicle 30a can include the number of a vehicle registration number plate of the vehicle 30a, an image of the vehicle 30a preliminarily stored in the storage unit 48, position information of the vehicle 30a, and the like. The connection request control unit 250 may cause the user 80c to recognize the vehicle 30a by the ECU in the vehicle 30a setting a light emitting device such as a direction indicator lamp or a hazard lamp to flash at a predetermined pattern. Note that the connection request control unit 250 transmits the same token information to the vehicle 30a as that transmitted to the user terminal 82c.

When the user 80c moves the user terminal 82c closer to the vehicle 30a, the user terminal 82c transmits the token information to the ECU in the vehicle 30a with short range radio communication. The ECU in the vehicle 30a, when the token information received from the management server 40 matches the token information received from the user terminal 82c, accepts the charging/discharging cable 22 to be connected to the vehicle 30a. For example, the ECU in the vehicle 30a opens a cover of an attachment opening for charging/discharging cable of the vehicle 30a.

The ECU in the vehicle 30a, upon detecting that the charging/discharging cable 22 is attached to the attachment opening for charging/discharging cable of the vehicle 30a, returns the token information received from the management server 40 to the management server 40. The price control unit 270, upon receiving the token information from the vehicle 30a, produces the price information indicating the price for connecting the vehicle 30a other than the user's own vehicle to the charging/discharging facility 20 for the user 80c as a destination of the connection request including the token information, and corresponds the produced price information to the user 80c. For example, as described above, the price control unit 270 gives the user 80c one point per each time frame. As described above, the price control unit 270 also gives the user 80a one point per each time frame.

FIG. 10 is a flowchart illustrating processing taken by the user 80 other than the user of the vehicle 30 to connect the vehicle 30 to the charging/discharging facility 20. The flowchart in FIG. 10 is executed mainly in the processing unit 42 of the management server 40. The processing of the flowchart in FIG. 10 is executed at a time point earlier for a predetermined time before the start time of the scheduled period for the vehicle 30 to transmit and receive power to/from the power network 10.

At S902, the connection permission acquisition unit 240 selects the vehicle 30 which is parked near the charging/discharging facility 20 and is not connected to the charging/discharging facility 20. At S904, it is determined whether any other user 80 is near the vehicle 30. For example, in the management server 40, the user 80 is preliminarily registered who can connect the vehicle 30 other than his/her own vehicle to the charging/discharging facility 20. The management server 40 determines whether any other user 80 is near the vehicle 30 based on the position information acquired from the user terminal 82 of the user 80.

When any other user 80 is near the vehicle 30, at S906, the inquiry information is transmitted to the user terminal 82 of the user 80 of the vehicle 30. At S908, the connection request control unit 250 determines whether the connection permission information is received from the user terminal 82 as the destination of the inquiry information. If the connection permission information is received, the connection request control unit 250, at S910, transmits the connection request including the token information to the user terminal 82 of the user 80 near the vehicle 30. At S912, the connection request control unit 250 transmits the token information to the vehicle 30.

At S914, the price control unit 270 determines whether the vehicle 30 is connected to the charging/discharging facility 20. For example, the price control unit 270 determines that the vehicle 30 is connected to the charging/discharging facility 20 when the token information is returned from the vehicle 30 that matches the token information transmitted from the management server 40 to the vehicle 30 at S912.

If it is determined at S914 that the vehicle 30 is connected to the charging/discharging facility 20, the price control unit 270 determines to give one point per time frame to the user 80 of the user terminal 82 as the destination of the connection request.

Note that if it is determined at S904 that any other user 80 is not near the vehicle 30, the processing of this flowchart is terminated. If the connection permission information is not received from the user terminal 82 as the destination of the inquiry information at S908 or if the vehicle 30 is not connected to the charging/discharging facility 20 at S914, the processing of this flowchart is also terminated.

According to the power transmission and reception system 100 as described above, the user 80 of the vehicle 30 can earn a higher price by connecting the vehicle 30 to the charging/discharging facility 20 at the scheduled period. In addition, even when the vehicle 30 is not connected to the charging/discharging facility 20, by any other user 80 near the vehicle 30 connecting the vehicle 30 to the charging/discharging facility 20, both users 80 can earn a price. As such, more vehicles 30 can be guided to be connected to the power network 10. This facilitates the power aggregator to ensure the capacity capable of transmitting and receiving power between the vehicle 30 and the power network 10. It then contributes to stabilization of the power network 10.

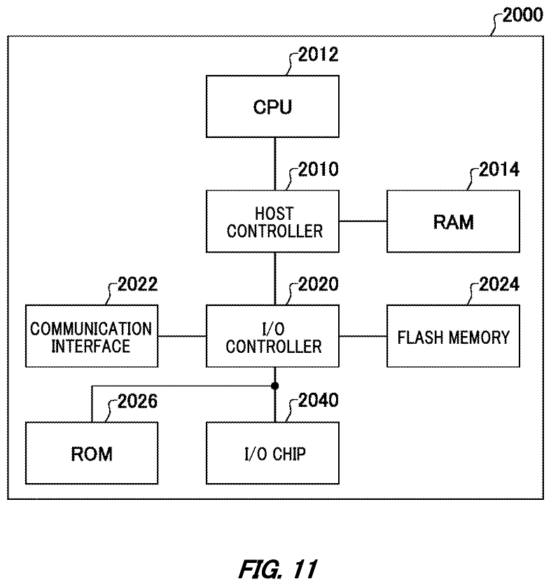

FIG. 11 shows an exemplary computer 2000 in which some embodiments of the present invention may be wholly or partially embodied. A program installed in the computer 2000 can cause the computer 2000 to function as an apparatus such as the management server 40 or each part of the apparatus according to the embodiments, perform operations associated with the apparatus or each part of the apparatus, and/or perform a process or steps of the process according to the embodiments. Such a program may be executed by a CPU 2012 to cause the computer 2000 to perform specific operations associated with some or all of the blocks in the processing steps and block diagrams described in the specification.

The computer 2000 according to the present embodiment includes the CPU 2012 and a RAM 2014, which are connected to each other via a host controller 2010. The computer 2000 also includes a ROM 2026, a flash memory 2024, a communication interface 2022, and an I/O chip 2040. The ROM 2026, the flash memory 2024, the communication interface 2022, and the I/O chip 2040 are connected to the host controller 2010 via an I/O controller 2020.

The CPU 2012 operates in accordance with a program stored in the ROM 2026 and the RAM 2014, thereby controlling each unit.

The communication interface 2022 communicates with other electronic devices via a network. The flash memory 2024 stores a program and data used by the CPU 2012 in the computer 2000. The ROM 2026 stores a boot program or the like executed by the computer 2000 upon activation, and/or a program dependent on hardware of the computer 2000. The I/O chip 2040 may also connect various I/O units, such as a keyboard, a mouse, and a monitor, to the I/O controller 2020 via I/O ports, such as a serial port, a parallel port, a keyboard port, a mouse port, a monitor port, an USB port, an HDMI (registered trademark) port, or the like.

The program is provided via a computer-readable medium, such as a CD-ROM, a DVD-ROM and a memory card, or a network. The RAM 2014, the ROM 2026, or the flash memory 2024 are an example of the computer-readable medium. The program is installed in the flash memory 2024, the RAM 2014, or the ROM 2026, and executed by the CPU 2012. Such a program describes information processing, which is read out by the computer 2000 to link the program with the various types of hardware resources as mentioned above. The apparatus or method may be configured by implementing information operation or processing using the computer 2000.

For example, upon communication between the computer 2000 and an external device, the CPU 2012 may execute a communication program loaded in the RAM 2014 and, based on the processing described in the communication program, instruct the communication interface 2022 to perform communication processing. The communication interface 2022, under control of the CPU 2012, reads out transmission data stored in a transmission buffer processing area provided in a recording medium such as the RAM 2014 and the flash memory 2024, transmits the read-out transmission data to a network, and writes received data from the network in a reception buffer processing area or the like provided on the recording medium.

The CPU 2012 may allow the RAM 2014 to read out all or necessary parts of a file or database stored in a recording medium such as the flash memory 2024, to perform various types of processing for the data stored on the RAM 2014. The CPU 2012 then writes back the processed data in the recording medium.

Various types of information such as various types of programs, data, tables, and databases may be stored in the storage medium for information processing. On the data read out from the RAM 2014, the CPU 2012 may perform various types of processing including various types of operations, information processing, condition determination, conditional branching, unconditional branching, and information retrieval/conversion, which are described anywhere in the specification and specified by an instruction sequence of a program, and write back the result in the RAM 2014. The CPU 2012 may also retrieve information in a file or database in the recording medium. For example, when the recording medium stores a plurality of entries each having a first attribute value associated with a second attribute value, the CPU 2012 may retrieve an entry from the plurality of entries that satisfies a condition where the first attribute value is specified, read out the second attribute value stored in the entry, thereby acquiring the second attribute value associated with the first attribute value that satisfies a predetermined condition.

The programs or software modules described above may be stored on the computer 2000 or a computer-readable medium in the vicinity of the computer 2000. A storage medium such as a hard disk or RAM provided in a server system connected to a dedicated communication network or the Internet is usable as a computer-readable medium. The program stored in the computer-readable medium may be provided to the computer 2000 via the network.

The program installed in the computer 2000 and causes the computer 2000 to function as the management server 40 may operate on the CPU 2012 or the like to cause the computer 2000 to function as each part of the management server 40. The information processing described in these programs are read out by the computer 2000 to function as specific means which embody cooperation of software and various types of hardware resources as described above, including the schedule information acquisition unit 210, the period specifying unit 230, the connection permission acquisition unit 240, the connection request control unit 250, the suggestion control unit 260, the price control unit 270, the power transmission and reception control unit 280, the demand information acquisition unit 290, the schedule information storage unit 282, and the price information storage unit 284. In addition, these specific means embody arithmetic operation or processing of information depending on purpose of use of the computer 2000 in the present embodiment to establish the management server 40 specific to the purpose of use.

Various embodiments have been described with reference to the block diagrams or the like. In the block diagrams, the respective blocks may represent: (1) steps of a process for performing operations; or (2) parts of an apparatus having functions to perform operations. A specific step or part may be implemented by a dedicated circuit, a programmable circuit provided with computer-readable instructions stored on a computer-readable medium, and/or a processor provided with computer-readable instructions stored on a computer-readable medium. The dedicated circuit may include a digital and/or analog hardware circuit, or may include an integrated circuit (IC) and/or a discrete circuit. The programmable circuit may include a reconfigurable hardware circuit, including logic operations such as logic AND, logic OR, logic XOR, logic NAND, logic NOR, and the like, as well as memory elements such as a flip-flop, a register, a field programmable gate array (FPGA), and a programmable logic array (PLA).

The computer-readable medium may include any tangible device that can store instructions to be performed by a suitable device, so that the computer-readable medium having instructions stored therein constitutes at least a part of a product including instructions that can be executed to configure means for performing operations specified in the processing steps or block diagrams. Examples of the computer-readable medium may include an electronic storage medium, a magnetic storage medium, an optical storage medium, a magneto-electric storage medium, and a semiconductor storage medium. More specific examples of the computer-readable medium may include a floppy (registered trademark) disk, a diskette, a hard disk, random access memory (RAM), read-only memory (ROM), erasable programmable read-only memory (EPROM or flash memory), electrically-erasable programmable read-only memory (EEPROM), static random access memory (SRAM), compact disc read-only memory (CD-ROM), a digital versatile disk (DVD), a Blu-ray (registered trademark) disk, a memory stick, and an integrated circuit card.

The computer-readable instructions may include assembler instructions, instruction set architecture (ISA) instructions, machine instructions, machine-dependent instructions, microcodes, firmware instructions, state setting data, or any of source codes or object codes described in any combination of one or more programming languages, including object-oriented programming languages, such as Smalltalk (registered trademark), JAVA (registered trademark), or C++, and conventional procedural programming languages, such as C programming languages or similar programming languages.

The computer-readable instructions may be provided to processors or programmable circuits of general-purpose computers, special-purpose computers, or other programmable data processing apparatuses, locally or via local area network (LAN) or wide area network (WAN) such as the Internet, wherein the computer-readable instructions are executed for providing means for performing the operations specified in the described processing steps or block diagrams. The processors include a computer processor, a processing unit, a microprocessor, a digital signal processor, a controller, and a microcontroller.

While the embodiments of the present invention have been described, the technical scope of the invention is not limited to the above-described embodiments. It is apparent to persons skilled in the art that various alterations and improvements can be added to the above-described embodiments. In addition, matters explained about a particular embodiment can be applied to another embodiment as long as such application does not cause technological contradictions. It is also apparent from the scope of the claims that the embodiments added with such alterations or improvements can be included in the technical scope of the invention.

The operations, procedures, steps, and stages of each process performed by an apparatus, system, program, and method shown in the claims, embodiments, or diagrams can be performed in any order as long as the order is not indicated by “prior to,” “before,” or the like and as long as the output from a previous process is not used in a later process. Even if the process flow is described using phrases such as “first” or “next” in the claims, embodiments, or diagrams, it does not necessarily mean that the process must be performed in this order.

### EXPLANATION OF REFERENCES

10: power network; 12: power generation facility; 14: stationary battery; 20: charging/discharging facility; 22: charging/discharging cable; 30: vehicle; 32: battery; 40: management server; 42: processing unit; 46: communication unit; 48: storage unit; 50: power transaction server; 80: user; 82: user terminal; 100: power transmission and reception system; 150: commercial facility; 210: schedule information acquisition unit; 230: period specifying unit; 240: connection permission acquisition unit; 250: connection request control unit 260: suggestion control unit 270: price control unit; 280: power transmission and reception control unit; 282: schedule information storage unit; 284: price information storage unit; 290: demand information acquisition unit; 300: screen; 310: selection menu; 320: input menu; 330: determination button; 2000: computer; 2010: host controller; 2012: CPU; 2014: RAM 2020: I/O controller; 2022: communication interface; 2024: flash memory; 2026: ROM; 2040: I/O chip

What is claimed is:

1. A power transmission and reception management apparatus comprising:
a period specifying unit configured to specify a period in which a vehicle having a driving power supply should be made available to transmit and receive power to/from a power network; and
a price control unit configured to, when the vehicle is made available to transmit and receive power to/from the power network in the period specified by the period specifying unit, produce price information for the vehicle being made available to transmit and receive power to/from the power network to correspond the price information to at least any of the vehicle, a user of the vehicle, a person who made the vehicle available to transmit and receive power to/from the power network, and a vehicle used by the person.

2. The power transmission and reception management apparatus according to claim 1, wherein:
the price control unit produces the price information when the vehicle and a power transmission and reception facility for transmitting and receiving power between the vehicle and the power network are connected to each other in the period specified by the period specifying unit.

3. The power transmission and reception management apparatus according to claim 2, further comprising:
a schedule information storage unit configured to correspond information indicating a scheduled period in which the vehicle is connected to the power transmission and reception facility to identification information of the vehicle for storage, wherein the period specifying unit specifies the scheduled period corresponded to the identification information of the vehicle and stored in the schedule information storage unit as a period in which the vehicle should be made available to transmit and receive power to/from the power network.

4. The power transmission and reception management apparatus according to claim 3, further comprising:
a schedule information acquisition unit configured to preliminarily acquire information for specifying the scheduled period from the user of the vehicle,
wherein the schedule information storage unit corresponds the period acquired by the schedule information acquisition unit to the identification information of the vehicle for storage.

5. The power transmission and reception management apparatus according to claim 4, wherein
the price control unit, when the power transmission and reception facility and the vehicle are connected to each other, produces first price information if a period in which the power transmission and reception facility and the vehicle are connected to each other does not include the scheduled period, and produces second price information indicating a higher price than that of the first price information if a period in which the power transmission and reception facility and the vehicle are connected to each other includes the scheduled period.

6. The power transmission and reception management apparatus according to claim 2, wherein the price control unit corresponds the price information to at least one of the user of the vehicle and any other person who connected the vehicle to the power transmission and reception facility.

7. The power transmission and reception management apparatus according to claim 6, wherein the price control unit corresponds the price information to the any other person when the vehicle, which has not been connected to the power transmission and reception facility before the period specified by the period specifying unit, is connected to the power transmission and reception facility by the any other person.

8. The power transmission and reception management apparatus according to claim 7, further comprising:
a connection request control unit configured to, when the vehicle is not connected to the power transmission and reception facility at a predetermined time point before the period specified by the period specifying unit, request the any other person to connect the vehicle to the power transmission and reception facility,
wherein the price control unit corresponds the price information to the any other person when the vehicle is connected to the power transmission and reception facility by the any other person who is requested to perform connection.

9. The power transmission and reception management apparatus according to claim 8, further comprising:
a connection permission acquisition unit configured to acquire permission information for permitting the any other person to connect the vehicle to the power transmission and reception facility from the user of the vehicle,
wherein the connection request control unit requests the any other person to connect the vehicle to the power transmission and reception facility under a condition that the connection permission acquisition unit acquires the permission information.

10. The power transmission and reception management apparatus according to claim 8, wherein:
the period specifying unit, based on a power demand in the power network, specifies a period in which power transmission and reception for the power network is required, and
the connection request control unit, at a predetermined time point before the period specified by the period specifying unit, requests the any other person near the vehicle, which is not connected to the power transmission and reception facility but parked in the vicinity of the power transmission and reception facility, to connect the vehicle to the power transmission and reception facility.

11. The power transmission and reception management apparatus according to claim 6, further comprising:
a price information storage unit configured to store information indicating an amount of the price information corresponded to each of the user and the any other person,
wherein the price control unit permits to use an electric facility for accumulating energy in the driving power supply preferentially depending on the amount of the price information corresponded to each of the user and the any other person.

12. The power transmission and reception management apparatus according to claim 1, wherein:
the period specifying unit, based on the period in which the vehicle is made available to transmit and receive power to/from the power network and history of the price information produced for the vehicle being made available to transmit and receive power to/from the power network, predicts a future period in which a price is generated by making the vehicle available to transmit and receive power to/from the power network and specifies the future period as a period in which the vehicle should be made available to transmit and receive power to/from the power network, and
the power transmission and reception management apparatus further comprises:
a suggestion control unit configured to suggest the future period predicted by the period specifying unit to the user of the vehicle.

13. The power transmission and reception management apparatus according to claim 3, wherein the price control unit corresponds the price information to at least one of the user of the vehicle and any other person who connected the vehicle to the power transmission and reception facility.

14. The power transmission and reception management apparatus according to claim 4, wherein the price control unit corresponds the price information to at least one of the user of the vehicle and any other person who connected the vehicle to the power transmission and reception facility.

15. The power transmission and reception management apparatus according to claim 5, wherein the price control unit corresponds the price information to at least one of the user of the vehicle and any other person who connected the vehicle to the power transmission and reception facility.

16. The power transmission and reception management apparatus according to claim 13, wherein the price control unit corresponds the price information to the any other person when the vehicle, which has not been connected to the power transmission and reception facility before the period specified by the period specifying unit, is connected to the power transmission and reception facility by the any other person.

17. The power transmission and reception management apparatus according to claim 14, wherein the price control unit corresponds the price information to the any other person when the vehicle, which has not been connected to the power transmission and reception facility before the period specified by the period specifying unit, is connected to the power transmission and reception facility by the any other person.

18. The power transmission and reception management apparatus according to claim 15, wherein the price control unit corresponds the price information to the any other person when the vehicle, which has not been connected to the power transmission and reception facility before the period specified by the period specifying unit, is connected to the power transmission and reception facility by the any other person.

19. The power transmission and reception management apparatus according to claim 16, further comprising:
a connection request control unit configured to, when the vehicle is not connected to the power transmission and reception facility at a predetermined time point before the period specified by the period specifying unit, request the any other person to connect the vehicle to the power transmission and reception facility,
wherein the price control unit corresponds the price information to the any other person when the vehicle is connected to the power transmission and reception facility by the any other person who is requested to perform connection.

20. Anon-transitory computer-readable storage medium having recorded thereon a program to cause a computer to perform operations comprising:
specifying a period in which a vehicle having a driving power supply should be made available to transmit and receive power to/from a power network; and
when the vehicle is made available to transmit and receive power to/from the power network in the specified period, producing price information for the vehicle being made available to transmit and receive power to/from the power network to correspond the price information to at least any of the vehicle, a user of the vehicle, a person who made the vehicle available to transmit and receive power to/from the power network, and a vehicle used by the person.
